(19) United States
(12) Patent Application Publication
(10) Pub. No.: US 2013/0292141 A1
(43) Pub. Date: Nov. 7, 2013

(54) SPRINKLER NOZZLE FOR FIRE SUPPRESSION SYSTEMS

(71) Applicant: Joseph Senecal, Wellesley, MA (US)

(72) Inventor: Joseph Senecal, Wellesley, MA (US)

(73) Assignee: UTC FIRE & SECURITY CORPORATION, Farmington, CT (US)

(21) Appl. No.: 13/976,136

(22) PCT Filed: Dec. 30, 2010
(86) PCT No.: PCT/US10/62471

§ 371 Date: Jun. 26, 2013

(51) Int. Cl. A62C 35/68

(52) U.S. Cl. CPC A62C 35/68
USPC 169/37

(57) ABSTRACT

An exemplary sprinkler nozzle includes a nozzle body having a sidewall, an internal passage and a plurality of slots through the sidewall to allow fluid to pass from the internal passage to an outside of the nozzle. Each of the slots has an axial dimension in a direction generally parallel to an axis of the nozzle body. Each of the slots has a second dimension in a different direction. At least a first one of the slots is axially offset from at least the second one of the slots. An opening provided by the first slot partially overlaps the opening of the second slot in the different direction.

### BACKGROUND

There are a variety of known fire suppression devices and systems. Most sprinkler-based systems include a plurality of sprinklers located near a ceiling and distributed about an area or room where fire protection is desired. There are various types of sprinkler-based systems and a variety of sprinkler nozzle types available.

For example, deluge systems disburse a relatively large amount of water into an area responsive to a fire condition. The sprinkler nozzles for such systems direct the water or other fluid in a desired spray pattern. Other sprinkler systems use a fine mist discharge from the sprinkler nozzles. The nozzle designed for such systems is typically more complicated for achieving the desired mist discharge.

One challenge associated with providing a sprinkler nozzle for a mist system is that it has to withstand relatively high pressures that are used in such systems. Another challenge is associated with the desire to reduce cost in such systems. Sprinkler heads that involve multiple parts introduce manufacturing and assembly cost, for example.

### SUMMARY

An exemplary sprinkler nozzle includes a nozzle body having a sidewall, an internal passage and a plurality of slots through the sidewall to allow fluid to pass from the internal passage to an outside of the nozzle. Each of the slots has an axial dimension in a direction generally parallel to an axis of the nozzle body. Each of the slots has a second dimension in a different direction. At least a first one of the slots is axially offset from at least the second one of the slots. An opening provided by the first slot partially overlaps the opening of the second slot in the different direction.

The various features and advantages of the disclosed example will become apparent to those skilled in the art from the following detailed description. The drawings that accompany the detailed description can be briefly described as follows.

### BRIEF DESCRIPTION OF THE DRAWINGS

FIG. 1 schematically illustrates an example sprinkler nozzle designed according to an embodiment of this invention.

FIG. 2 is a cross-sectional illustration of the example embodiment of FIG. 1.

FIG. 3 is a cross-sectional illustration of another example embodiment.

### DETAILED DESCRIPTION

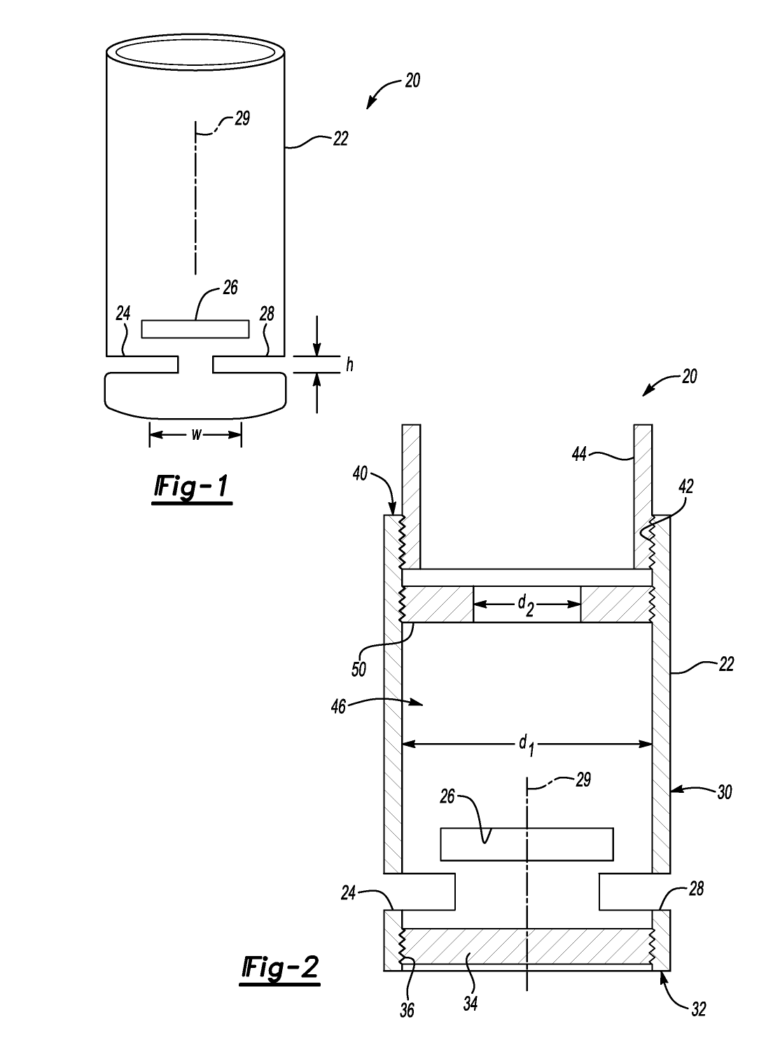

FIG. 1 illustrates an example sprinkler nozzle 20. This example comprises a generally cylindrical nozzle body 22. A plurality of slots 24, 26 and 28 allow a fire suppressing fluid to be discharged from the nozzle 20. The slots 24-28 are arranged in the nozzle body 22 to allow the nozzle body 22 to be formed as a single piece of material.

As can be appreciated from the illustration, the slot 26 is axially offset relative to the slots 24 and 28 when considered along a direction parallel to an axis 29 of the nozzle body 22. The opening of the slot 26 partially overlaps the opening of each of the slots 24 and 28 in a second, different direction. In this example, the orientation of the slots relative to each other and the nozzle body 22 provides the partial overlapping of the openings in a direction that is generally perpendicular to the axial direction along the axis 29 of the nozzle body 22.

Having axially offset slots and partially overlapping slots in a circumferential direction allows for establishing a desired spray pattern without completely interrupting the body 22 at any axial position of the body 22. The illustrated example slot pattern therefore allows for using a single-piece body construction and avoids the necessity of providing multiple nozzle parts to establish a desired spray pattern.

Each of the slots 24, 26 and 28 has a width dimension w taken in the second direction. Each of the slots 24, 26 and 28 also has a height dimension h along the axial direction of the nozzle body 22. In one example w is at least twice as large as h. The slots 24, 26 and 28 are dimensioned to establish a desired discharge from the nozzle body 22 such as a fine mist spray. The position of the slots 24, 26 and 28 relative to each other are arranged to establish a desired spray pattern from the nozzle 20. For example, the spray pattern may comprise an entire circle. Another example spray pattern may be generally conical when the sprinkler nozzle 20 is installed near a corner of a room, for example. The position and orientation of the slots will determine the spray pattern from the nozzle 20.

One feature of the circumferential slots 24-28 is that they each establish a plurality of discharge vectors. This provides a plurality of fluid streamlines, each following one of the discharge vectors. The fluid streamlines have a tendency to separate from each other as the fluid moves further away from the nozzle, which results in a radially expanding fluid sheet discharge from each slot. The combination of several such slots allows for establishing a desired spray pattern and to achieve uniform coverage throughout a target area. Additionally, a radially expanding fluid sheet will have a more uniform pressure profile above its surface and create less turbulence compared to a round fluid jet. This allows for more freedom in nozzle configuration.

Another feature of the example slots 24-28 is that the angle at which they penetrate through the nozzle body 22 may be varied to achieve desired discharge characteristics. For example, the slots 24 and 28 may extend through the sidewall of the nozzle body 22 at an oblique angle that is aimed more downward than the angle at which the slot 26 extends through the body 22. The slot 26 may be oriented to direct fluid discharge further outward away from the nozzle 20 while the slots 24 and 28 direct discharge more directly underneath the nozzle 20, for example. The example slots are illustrated extending through the sidewall of the nozzle body generally perpendicular to the axis 29. Other examples include one or more slots that extend through the nozzle body 22 at a variety of oblique angles relative to the axis 29.

FIG. 2 is a cross-sectional illustration showing selected features of the example sprinkler nozzle 20. The nozzle body 22 in this example comprises a generally cylindrical section 30 of material such as metal. The cylindrical section 30 establishes the sidewalls of the nozzle body 22. As can be appreciated from the drawing, the example slots 24 and 28 extend through the sidewalls of the nozzle body 22 at approximately 90 degrees relative to the axis 29.

One end 32 of the cylindrical section 30 is closed off by a cap 34. In this example, the cap is threaded as schematically shown at 36 into the end 32 of the cylindrical section 30. The cap 34 closes off the end of the nozzle body 22 closest to the slots 24-28 in this example.

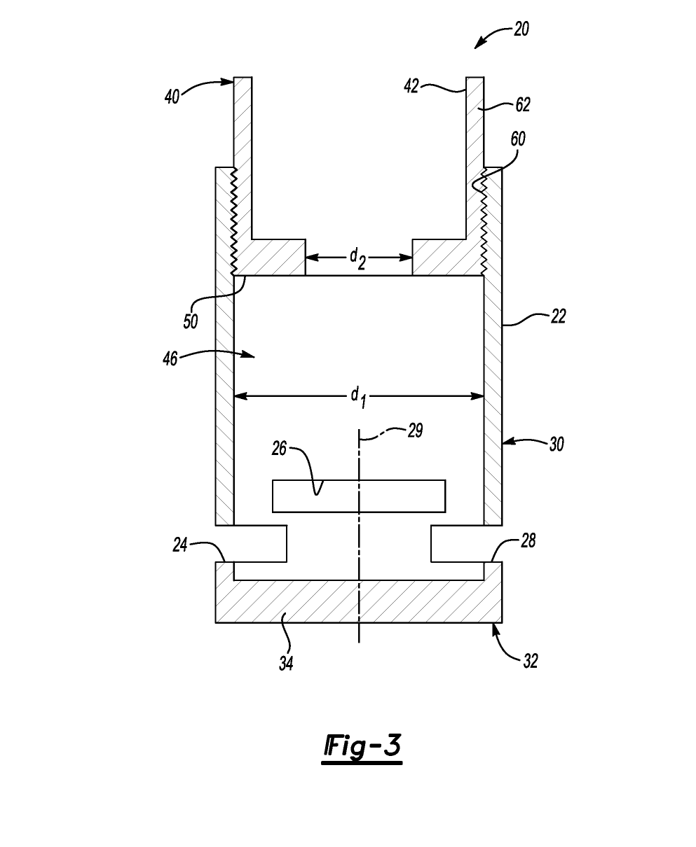

An opposite end 40 of the nozzle body 22 defines an attachment feature 42 for connecting the nozzle 20 to a fluid supply conduit 44 such as a pipe through which water flows. In this example, the attachment feature 42 allows for the sprinkler nozzle body 22 to be threadedly connected to an end of the pipe 44. In another example, such as that shown in FIG. 3, the attachment feature 42 facilitates a welded or other connection between the nozzle body and a correspondingly configured conduit.

The nozzle body 22 includes an internal passage 46 through which fluid flows into the nozzle 20 so that it can be disbursed through the slots 24, 26 and 28 responsive to a fire condition. The internal passage 46 has an inside dimension d1 which corresponds to an inner diameter of the cylindrical section 30 in this example. A flow restrictor 50 has a second, smaller dimension d2 for restricting an amount of fluid that flows into the internal passage 46. As can be appreciated from the illustration, the dimension d2 of the restrictor 50 is smaller than an inner dimension of the supply pipe 44. The flow restrictor 50 controls the amount of fluid provided to the nozzle 20 for purposes of regulating the discharge through the slots 24, 26 and 28. One example includes an opening size of the restrictor 50 that is greater than 10% and less than 70% of the inner diameter of the fluid supply conduit 44.

In one example, the restrictor 50 is integrally formed as a part of the nozzle body 22. In the example of FIG. 2, the restrictor 50 comprises a separate component that is connected with a portion of the cylindrical section 30. One feature of having a flow restrictor as a separate piece allows for selecting one of several different flow restrictor sizes for use with a “universal” or single-sized nozzle body 22 to achieve different flow rates in different nozzles. This allows for using one size nozzle body 22 and different restrictor sizes to achieve different discharge rates at different nozzle locations within a single system, for example. Similarly, the same nozzle body size 22 can be used in different sprinkler systems but different flow rates may be achieved in each by using different flow restrictors 50 in each installation, for example.

FIG. 3 shows another example arrangement in which the flow restrictor 50 is integrated as part of the nozzle body 22. In this example, the cylindrical section 30 has a threaded portion 60 that facilitates securing a second body portion 62 to the cylindrical section. The second body portion 62 includes the restrictor 50. It is possible, for example, to have one size cylindrical section 30 and differently sized second body portions 62 to realize different nozzles having different flow or discharge characteristics, depending on the second body portion selected for a particular installation. Another feature of the example of FIG. 3 is that the cap 34 is an integral part of the cylindrical section 30 instead of being a separate piece.

The various example features are interchangeable with each other even if they are not shown in the same illustration. It is possible, for example to combine several features of FIGS. 2 and 3 in a different combination compared to those that are illustrated. With the disclosed examples, it is possible to use various body portions, flow restrictors or slotted portions to realize different nozzle configurations without having to manufacture and stock a variety of nozzles.

The slots 24-28 have a total flow area through which fluid is discharged from the nozzle 20. The flow area of the slots 24-28 is selected to have a relationship to at least one of the cross-sectional area of the cylindrical section 30, the cross-sectional area of the flow restrictor 50 or the cross-sectional area of the supply conduit 44. In one example the flow area of the slots 24-28 collectively is approximately equal to the cross-sectional area of the supply conduit 44. In another example, the flow area of the slots 24-28 collectively is approximately equal to the cross-sectional area of the flow restrictor 50. In still another example, the flow area of the slots 24-28 collectively is approximately equal to the cross-sectional area of the interior of the cylindrical section 30.

The illustrated nozzle designs allow for a relatively straight-forward manufacturing and assembly process. For example, a single-piece construction can be used to establish the nozzle body 22 and the slots 24, 26 and 28. This reduced complexity compared to multiple piece nozzle designs provides cost savings because the manufacturing process required to make the piece is less complex and less labor intensive. Even in examples where a cap 34 and restrictor 50 comprise different pieces, the simplicity of the nozzle design is still advantageous compared to more complex designs.

One example includes using a single blank of material for the nozzle body 22 and machining the internal passage 46 and slots 24-28 into the blank. One example includes using electro-discharge machining to achieve the desired configuration of the single-pieced nozzle body 22. Such an approach is more cost-effective compared to multiple-piece nozzle designs.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A sprinkler nozzle, comprising:
a nozzle body having a sidewall, an internal passage and a plurality of slots through the sidewall to allow fluid to pass from the internal passage to an outside of the nozzle, each of the slots having an axial dimension in a direction generally parallel to an axis of the nozzle body and a second dimension in a different direction, at least a first one of the slots being axially offset from at least a second one of the slots, an opening provided by the first slot partially overlapping the opening of the second slot in the different direction, wherein the slots collectively have a cross-sectional area that defines a flow area and wherein the flow area has a selected relationship to at least one of
a cross-sectional area of the nozzle body,
a cross-sectional area of a supply conduit that provides fluid to the nozzle, or.
a cross-sectional area of a flow restrictor that controls an amount of fluid that is introduced into the nozzle body.

2. The sprinkler nozzle of claim 1, wherein the different direction is generally perpendicular to the axis.

3. The sprinkler nozzle of claim 1, wherein the second dimension is greater than the axial dimension.

4. The sprinkler nozzle of claim 3, wherein the second dimension is at least twice the axial dimension.

5. The sprinkler nozzle of claim 1, comprising a first set of the slots at a first axial position on the nozzle body and a second set of the slots at a second, different axial position on the body.

6. The sprinkler nozzle of claim 1, wherein the slots are positioned about a periphery of the nozzle body to achieve a desired spray pattern from the nozzle.

7. The sprinkler nozzle of claim 6, wherein the desired spray pattern comprises a complete circle.

8. The sprinkler nozzle of claim 1, wherein each slot provides a spray pattern of fluid having a plurality of different trajectory angles.

9. The sprinkler nozzle of claim 1, wherein the internal passage has a first opening size and comprising a flow restrictor portion with a second, smaller opening size, the flow restrictor portion being between an entry to the internal passage and the plurality of slots.

10. The sprinkler nozzle of claim 9, wherein the nozzle body defines an attachment feature configured to be attached to a fluid supply conduit and the second opening size of the restrictor portion is smaller than an inner dimension of a flow passage in the conduit.

11. The sprinkler nozzle of claim 1, wherein
the nozzle body comprises a cylindrical section of material, a cap closing off an end of the cylindrical section and an attachment feature near an opposite end of the cylindrical section,
the attachment feature is configured to attach the nozzle body to a fluid supply conduit,
the plurality of slots are through the cylindrical section and
the plurality of slots are closer to the cap than the attachment.

12. The sprinkler nozzle of claim 11, wherein the cap comprises threads and the cylindrical section is threaded for connecting the cap to the cylindrical section.

13. The sprinkler nozzle of claim 11, wherein the cylindrical section comprises a first portion including the slots and a second portion having a flow restrictor and wherein the first and second portions comprise individual pieces that are secured together.

14. The sprinkler nozzle of claim 1, wherein the nozzle body comprises a single piece of material.

15. The sprinkler nozzle of claim 1, wherein the slots establish a spray pattern from the nozzle and the spray pattern comprises a radially spreading fluid sheet from each of the slots.

16-18. (canceled)

19. A sprinkler nozzle, comprising:
a nozzle body having a sidewall, an internal passage and a plurality of slots through the sidewall to allow fluid to pass from the internal passage to an outside of the nozzle, each of the slots having an axial dimension in a direction generally parallel to an axis of the nozzle body and a second dimension in a different direction, at least a first one of the slots being axially offset from at least a second one of the slots, an opening provided by the first slot partially overlapping the opening of the second slot in the different direction, wherein each slot provides a spray pattern of fluid having a plurality of different trajectory angles.

20. A sprinkler nozzle, comprising:
a nozzle body having a sidewall, an internal passage and a plurality of slots through the sidewall to allow fluid to pass from the internal passage to an outside of the nozzle, each of the slots having an axial dimension in a direction generally parallel to an axis of the nozzle body and a second dimension in a different direction, at least a first one of the slots being axially offset from at least a second one of the slots, an opening provided by the first slot partially overlapping the opening of the second slot in the different direction, wherein the slots establish a spray pattern from the nozzle and the spray pattern comprises a radially spreading fluid sheet from each of the slots.
